(19) United States
(12) Patent Application Publication
(10) Pub. No.: US 2025/0178123 A1
(43) Pub. Date: Jun. 5, 2025

(54) BONDING METHOD

(71) Applicant: Mitsubishi Electric Corporation, Tokyo (JP)

(72) Inventors: Shohei OGAWA, Tokyo (JP); Yuki YANO, Tokyo (JP)

(73) Assignee: Mitsubishi Electric Corporation, Tokyo (JP)

(21) Appl. No.: 18/842,385

(22) PCT Filed: May 25, 2022
(86) PCT No.: PCT/JP2022/021369

§ 371 Date: Aug. 28, 2024

(51) Int. Cl. B23K 26/06; B23K 1/005; B23K 26/03

(52) U.S. Cl. CPC B23K 26/0626; B23K 1/0056; B23K 26/034

(57) ABSTRACT

A highly stable bond is obtained with variations in the bond being suppressed. A bonding method includes: disposing a temperature measurement unit such that temperatures of a first component and a second component can be measured; measuring the temperatures of the first component and the second component using the temperature measurement unit, with the second component being irradiated with a laser beam; reducing output of the laser beam when the measured temperature of the second component is higher than or equal to a first threshold value; and terminating the output of the laser beam when the measured temperature of the first component is higher than or equal to a second threshold value after the temperature of the second component is higher than or equal to the first threshold value.

### TECHNICAL FIELD

The technology disclosed in this DESCRIPTION relates to a bonding technology.

### BACKGROUND ART

For example, in Patent Document 1, irradiation of a laser beam heats wire, and the wire is soldered through the heat conduction.

Furthermore, an infrared thermal detector detects the temperature of the wire heated by the irradiation of the laser beam. Then, irradiation output of the laser beam is controlled so that the detected temperature matches a preset temperature.

### PRIOR ART DOCUMENT

### Patent Document

Patent Document 1: Japanese Patent Application Laid-Open No. S63-043791

### SUMMARY

### Problem to be Solved by the Invention

In Patent Document 1, the infrared thermal detector detects the temperature of the wire. Then, the irradiation output of the laser beam is controlled based on the detected temperature of the wire. Here, a thermal contact resistance between a surface of the wire that is irradiated with the laser beam and a bonding surface of solder disposed to face the irradiated surface causes heat conduction between these surfaces to vary. This consequently causes variations in soldering quality in some cases.

When thermal capacity of a material to be irradiated with a laser beam is sufficiently high, the material even heated by the laser beam is not sufficiently subjected to an elevated temperature. This makes it difficult to stabilize the bond. To address this, increasing the irradiation output of the laser beam leads to an excessive rise in the temperature of the material. This sometimes damages heat sensitive components (e.g., a semiconductor element or a resin molded component) in the vicinity of the surface irradiated with the laser beam. Moreover, a sudden and local temperature rise sometimes melts a metal on the surface irradiated with the laser beam, and causes scrap metals referred to as spatters to be scattered to the surroundings. In such a case, the scrap metals may damage components in the vicinity of the surface irradiated with the laser beam, or cause a short in an insulated portion.

The technology disclosed in this DESCRIPTION has been conceived in view of the aforementioned problems, and is a technology for obtaining a highly stable bond with variations in the bond being suppressed.

### Means to Solve the Problem

A bonding method according to a first aspect of the technology disclosed in the DESCRIPTION includes: disposing a bonding material on an upper surface of a first component; disposing a second component on an upper surface of the bonding material; disposing a temperature measurement unit such that temperatures of the first component and the second component can be measured; measuring the temperatures of the first component and the second component using the temperature measurement unit, with the second component being irradiated with a laser beam; reducing output of the laser beam when the measured temperature of the second component is higher than or equal to a first threshold value; and terminating the output of the laser beam when the measured temperature of the first component is higher than or equal to a second threshold value after the temperature of the second component is higher than or equal to the first threshold value.

### Effects of the Invention

At least the first aspect of the technology disclosed in the DESCRIPTION enables obtainment of a stable bond by measuring, using the temperature measurement unit, temperature states of the first component and the second component and appropriately controlling the output of the laser beam according to the temperature states in heating by irradiation of a laser beam, without damaging peripheral components with low heat resistance while avoiding excessive energy input.

The object, features, aspects, and advantages related to the technology disclosed in the DESCRIPTION will become more apparent from the following detailed description and the accompanying drawings.

### BRIEF DESCRIPTION OF DRAWINGS

FIG. 1 is a flowchart for illustrating example processes of a bonding method according to an embodiment.

FIG. 2 illustrates the example processes of the bonding method according to the embodiment.

FIG. 3 illustrates example processes of a bonding method according to an embodiment.

FIG. 4 illustrates other example processes of the bonding method according to the embodiment.

FIG. 5 illustrates example processes of a bonding method according to an embodiment.

FIG. 6 illustrates example processes of a bonding method according to an embodiment.

FIG. 7 is a flowchart for illustrating example processes of a bonding method according to an embodiment.

FIG. 8 illustrates the example processes of the bonding method according to the embodiment.

### DESCRIPTION OF EMBODIMENTS

Embodiments will be hereinafter described with reference to the attached drawings. Although detailed features are described in Embodiments below for description of the technology, they are mere exemplification and not necessarily essential features for making Embodiments feasible.

Note that the drawings are drawn in schematic form, and structures are appropriately omitted or simplified for convenience of description. The mutual relationships in size and position between the structures in different drawings are not necessarily accurate but may be appropriately changed. The drawings such as plan views except cross-sectional views are sometimes hatched for facilitating the understanding of the details of Embodiments.

In the following description, the same reference numerals are assigned to the same constituent elements, and their names and functions are the same. Therefore, detailed description of such constituent elements may be omitted to avoid redundant description.

Unless otherwise specified, an expression “comprising”, “including”, or “having” a certain constituent element is not an exclusive expression for excluding the presence of the other constituent elements in this DESCRIPTION.

Even when the ordinal numbers such as “first” and “second” are used in the DESCRIPTION, these terms are used for convenience to facilitate the understanding of the details of Embodiments. The order that may be indicated by these ordinal numbers does not restrict the details of Embodiments.

In the DESCRIPTION, even when terms expressing a particular position and a particular direction such as “up”, “down”, “left”, “right”, “side”, “bottom”, “front”, or “back” are used, these terms are used for convenience to facilitate the understanding of the details of Embodiments, and do not relate to positions or directions when Embodiments are actually employed.

In the DESCRIPTION, the expression of, for example, “an upper surface of” or “a lower surface of” a target constituent element includes states where not only the upper surface or the lower surface of the target constituent element itself is formed but also another constituent element is formed on the upper surface or the lower surface of the target constituent element. Specifically, for example, the expression “B formed on the upper surface of A” does not hinder interposition of another constituent element “C” between A and B.

### Embodiment 1

A bonding method according to Embodiment 1 will be hereinafter described.

### [Construction of Bonding Method]

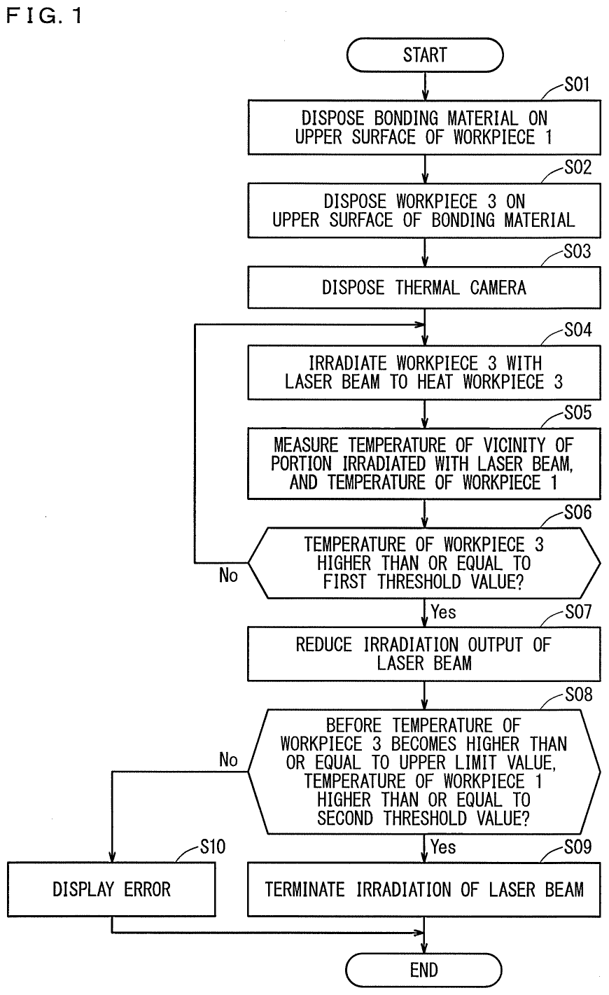

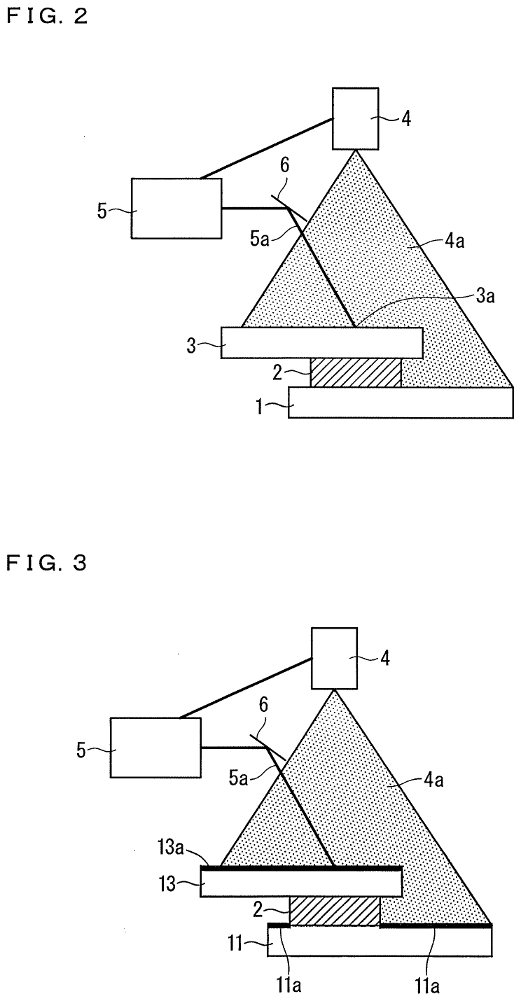

FIG. 1 is a flowchart for illustrating example processes of the bonding method according to Embodiment 1. FIG. 2 illustrates the example processes of the bonding method according to Embodiment 1. The bonding method will be hereinafter described with reference to FIGS. 1 and 2.

First, a bonding material 2 is disposed on an upper surface of a workpiece 1 (Step S01 in FIG. 1). Furthermore, a workpiece 3 is disposed on an upper surface of the bonding material 2 (Step S02 in FIG. 1). Here, the bonding material 2 is, for example, Sn—Ag—Cu based solder.

Next, a thermal camera 4 is disposed such that the temperatures of both of the workpieces 3 and 1 can be detected (Step S03 in FIG. 1). FIG. 2 illustrates a range in which the thermal camera 4 can capture an image (i.e., a range in which the temperature can be detected) as a region 4a. Then, a laser light source 5 irradiates the workpiece 3 with a laser beam 5a to heat the workpiece 3 (Step S04 in FIG. 1). Here, the thermal camera 4 measures the temperature of the vicinity of a irradiated portion 3a irradiated with the laser beam 5a in the workpiece 3, and the temperature of the workpiece 1 (Step S05 in FIG. 1).

Next, whether the temperature of the workpiece 3 is higher than or equal to a predefined first threshold value (e.g., a liquidus temperature of solder) is determined (Step S06 in FIG. 1). When the temperature of the workpiece 3 measured by the thermal camera 4 is lower than the first threshold value, the processes return to Step ST04 in FIG. 1 to continue heating the workpiece 3. When the temperature of the workpiece 3 is higher than or equal to the first threshold value, the irradiation output of the laser beam 5a is reduced in Step S07 of FIG. 1. Then, the processes proceed to Step ST08 in FIG. 1.

In Step ST08 of FIG. 1, whether the temperature of the workpiece 1 is higher than or equal to a predefined second threshold value (e.g., a liquidus temperature of solder) before the temperature of the workpiece 3 becomes higher than or equal to a predefined upper limit value (e.g., a temperature obtained by adding 20° C. to the liquidus temperature of solder) is determined. When the temperature of the workpiece 1 is higher than or equal to the second threshold value before the temperature of the workpiece 3 becomes higher than or equal to the upper limit value, irradiation of the laser beam 5a is terminated in Step® S09 of FIG. 1, and the bonding through the bonding material 2 is completed. When the temperature of the workpiece 1 does not become higher than or equal to the second threshold value before the temperature of the workpiece 3 becomes higher than or equal to the upper limit value (i.e., although the temperature of the workpiece 3 irradiated with the laser beam 5a becomes higher than or equal to the upper limit value, the temperature of the workpiece 1 has not become higher than or equal to the second threshold value yet), a device displays an error as a bonding defect in which heat is not sufficiently transferred to the workpiece 1 in Step S10 of FIG. 1, and terminates the operations.

FIG. 2 illustrates an example structure of the device that implements the flowchart described in FIG. 1. The example of FIG. 2 assumes a Galvano scanner method of controlling the laser beam 5a irradiated by the laser light source 5, using a reflector 6 in any direction. However, the irradiating method of the laser beam 5a is not limited to such a method, but may be a method of directly driving a laser head along a drive shaft, coaxially using the laser light source 5 and the laser beam 5a.

Although the bonding material 2 in the example of FIG. 2 is Sn—Ag—Cu based solder, the alloy composition is not limited to a Sn—Ag—Cu based composition. The bonding material 2 may be obtained by interposing plate solder molded in advance, between the workpieces 1 and 3, or dispense coating or screen printing paste solder obtained by mixing flux. Furthermore, reserve solder may be applied to the workpiece 1 or 3 in advance. Alternatively, a bonding material such as a brazing filler metal may be used instead of solder. Alternatively, at least one of the workpieces may be melted without using the bonding material 2 to directly weld the workpieces.

The workpiece 1 or 3 is preferably made of a metal such as Cu, Al, or SUS. Furthermore, the workpiece 1 or 3 may be plated with, for example, Ni, Sn, or Au. Furthermore, the workpiece 1 may be a surface electrode disposed on an upper surface of a semiconductor element.

Although the first threshold value, the upper limit value, and the second threshold value that indicate temperatures set as parameters for controlling the irradiation output of the laser beam from the laser light source 5 are liquidus temperatures of solder or temperatures obtained by adding 10° C. or 20° C. to the liquidus temperatures of solder, the temperatures are not limited to these. The temperature to be added to the liquidus temperatures is not limited to 10° C. or 20° C.

The thermal camera 4 is disposed at a place and a distance where measurement of the temperatures is possible by capturing images of the workpieces 1 and 3 and the bonding material 2. Typically, a light source that operates at wavelengths of light easily absorbed by metals is used as the laser light source 5 for the purpose of metal welding, such as a YAG laser or a fiber laser. The laser light source 5 is not limited to these, but, for example, a semiconductor laser, a CO₂ laser, a disc laser may be used.

When the temperature of the workpiece 1 that is not directly irradiated with the laser beam 5a is low and the bonding material 2 is melted due to the temperature rise in a bonding process, the bonding material 2 inferiorly wets out to the workpiece 1, and a fillet profile to be formed is not stable. Thus, the bonding reliability decreases. If the temperature in bonding is increased by increasing the irradiation output of the laser beam 5a to avoid such decrease in the reliability, the heat in irradiation of the laser beam may damage heat sensitive peripheral components (e.g., a semiconductor element to be bonded to a lead, or insert mold resin to be bonded to a lead that has been insert molded with resin with a low melting point). Thus, managing the temperatures of the workpieces 1 and 3 and the bonding material 2 during irradiation of the laser beam is important.

Implementing the processes described in Embodiment 1 can form a bond with high reliability without damaging components in the vicinity of the workpieces 1 and 3, even when the thermal contact resistance unexpectedly increases due to, for example, a foreign substance that gets caught between the workpiece 1 and the bonding material 2 or between the bonding material 2 and the workpiece 3. Furthermore, when the temperature rise in the workpiece 3 is delayed in the bonding processes, the bonding malfunction can be detected at the site.

Furthermore, simultaneously measuring the temperatures of the components included in the region 4a that is relatively wide, using the thermal camera 4 enables simultaneous measurement of the temperatures of the workpieces 1 and 3. This can prevent the laser beam 5a from irregularly reflecting, prevent an increase in the temperatures of portions except the irradiated portion 3a, and prevent the other components from damaging.

### Embodiment 2

A bonding method according to Embodiment 2 will be described. In the following description, the same reference numerals are assigned to the same constituent elements as those in Embodiment 1, and the detailed description will be appropriately omitted.

### [Construction of Bonding Method]

FIG. 3 illustrates example processes of a bonding method according to Embodiment 2. In the example of FIG. 3, the bonding material 2 is disposed on an upper surface of a workpiece 11. Furthermore, a workpiece 13 is disposed on the upper surface of the bonding material 2. Here, on the surface of the workpiece 11 on which the bonding material 2 is mounted (i.e., the upper surface), a region except a location at which the bonding material 2 is disposed is subjected to a blackening treatment 11a for temperature monitoring. Furthermore, a surface of the workpiece 13 that is not in contact with the bonding material 2 (i.e., the upper surface) is subjected to a blackening treatment 13a for temperature monitoring.

Although the entire region except the location at which the bonding material 2 is disposed in the workpiece 11 is subjected to the blackening treatment 11a in FIG. 3, a part of the region except the location at which the bonding material 2 is disposed may be subjected to the blackening treatment 11a.

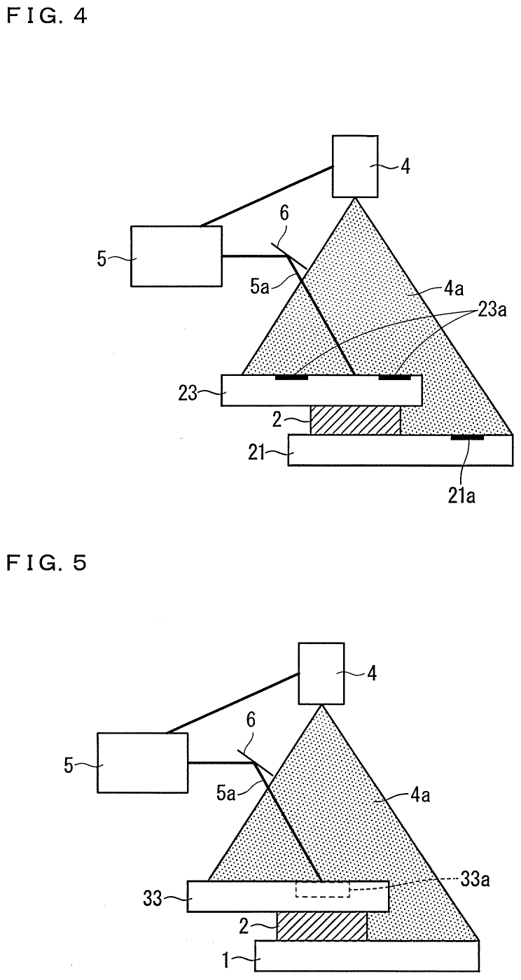

FIG. 4 illustrates other example processes of the bonding method according to Embodiment 2. In the example of FIG. 4, the bonding material 2 is disposed on an upper surface of a workpiece 21. Furthermore, a workpiece 23 is disposed on the upper surface of the bonding material 2. Here, on the surface of the workpiece 21 on which the bonding material 2 is mounted (i.e., the upper surface), a part of a region except the location at which the bonding material 2 is disposed is subjected to a blackening treatment 21a for temperature monitoring. Furthermore, parts of the surface of the workpiece 23 that are not in contact with the bonding material 2 (i.e., the upper surface) are subjected to a blackening treatment 23a for temperature monitoring.

As described above, the region subjected to the blackening treatment may be only a region to be used for temperature monitoring. The blackening treatment may be applied by spraying black paint on the surface of a workpiece, or by black plating (e.g., chrome plating, an alumite treatment, zinc plating) on the surface.

The blackening treatment is suppressing variations in the temperature to be measured by differences in radiation ratio (emissivity) of the surface when the temperature is measured by the thermal camera 4. Thus, a method except the blackening treatment may be used as long as the method can suppress the variations in radiation ratio (emissivity). For example, when a workpiece is made of Cu, the workpiece may be subjected to a bake treatment in advance, or a surface oxide film may be formed on the workpiece by irradiation of a laser beam with low output.

The thermal camera 4 detects infrared rays emitted from an object to measure the temperature of the object. Thus, as variations in radiation ratio (emissivity) of an object are smaller, the measurement accuracy tends to be stable.

Subjecting a workpiece to a blackening treatment can reduce variations in measured temperatures which are caused by variations in radiation ratio (emissivity) of the workpiece, and control the irradiation output of the laser beam 5a with high accuracy. Thus, for example, when the melting point of the bonding material 2 is closer to heat resistance temperatures of the peripheral components or when peripheral components with low heat resistance temperatures are disposed closer to a bond, the thermal effects on these peripheral components can be kept to a minimum.

### Embodiment 3

A bonding method according to Embodiment 3 will be described. In the following description, the same reference numerals are assigned to the same constituent elements as those in Embodiments 1 and 2, and the detailed description will be appropriately omitted.

### [Construction of Bonding Method]

FIG. 5 illustrates example processes of a bonding method according to Embodiment 3. In the example of FIG. 5, the bonding material 2 is disposed on the upper surface of the workpiece 1. Furthermore, a workpiece 33 is disposed on the upper surface of the bonding material 2. Here, a recess 33a is formed in a portion to be irradiated with the laser beam 5a, on a surface of the workpiece 33 which is not in contact with the bonding material 2 (i.e., the upper surface). The thickness of the recess 33a is half the thickness of another portion of the workpiece 33 in which the recess 33a is not formed.

Not only the portion to be irradiated with the laser beam 5a but also a region including another portion (e.g., a portion for temperature monitoring) may be thinned. The thickness of the recess 33a is not limited to half the thickness of the other portion of the workpiece 33 as long as the thermal responsiveness can be increased.

Thinning the portion to be irradiated with the laser beam 5a reduces the thermal capacity of the portion in the workpiece 33. This increases not only the thermal responsiveness but also the heat transfer efficiency to the bonding material 2 and the workpiece 1 through the workpiece 33. Thus, a stable bond can be obtained in a short period of time. Furthermore, thinning up to the portion for temperature monitoring enables measurement of the temperatures of the workpiece 33, the bonding material 2, and the workpiece 1 that are being irradiated with a laser beam with high accuracy.

The workpiece 33 or the workpiece 1 illustrated in FIG. 5 may be subjected to the blackening treatment illustrated in FIG. 3 or 4.

### Embodiment 4

A bonding method according to Embodiment 4 will be described. In the following description, the same reference numerals are assigned to the same constituent elements as those in Embodiments 1 to 3, and the detailed description will be appropriately omitted.

### [Construction of Bonding Method]

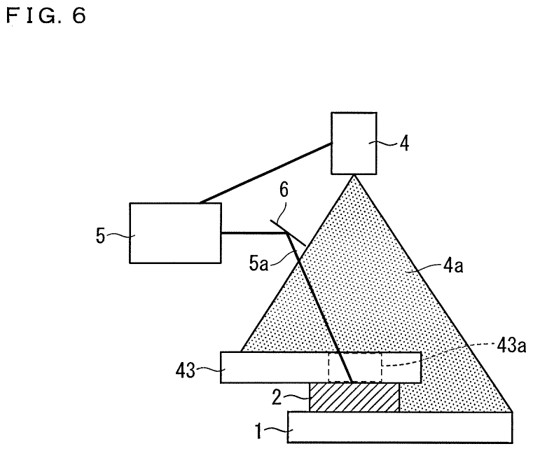

FIG. 6 illustrates example processes of a bonding method according to Embodiment 4. In the example of FIG. 6, the bonding material 2 is disposed on the upper surface of the workpiece 1. Furthermore, a workpiece 43 is disposed on the upper surface of the bonding material 2. Here, an opening 43a is formed in a portion of the workpiece 43 to be irradiated with the laser beam 5a. The opening 43a is a hole penetrating from the upper surface to the lower surface of the workpiece 43. The bonding material 2 exposed from the opening 43a is directly irradiated with the laser beam 5a with which the opening 43a is irradiated.

Forming the opening 43a in the workpiece 43 enables the bonding material 2 to be directly heated by the laser beam 5a. This can avoid a shortage of heat transfer to the bonding material 2 and the workpiece 1 which is caused by a large thermal contact resistance between the workpiece 43 and the bonding material 2. Consequently, a stable bond can be obtained.

The workpiece 43 or the workpiece 1 illustrated in FIG. 6 may be subjected to the blackening treatment illustrated in FIG. 3 or 4.

### Embodiment 5

A bonding method according to Embodiment 5 will be described. In the following description, the same reference numerals are assigned to the same constituent elements as those in Embodiments 1 to 4, and the detailed description will be appropriately omitted.

### [Construction of Bonding Method]

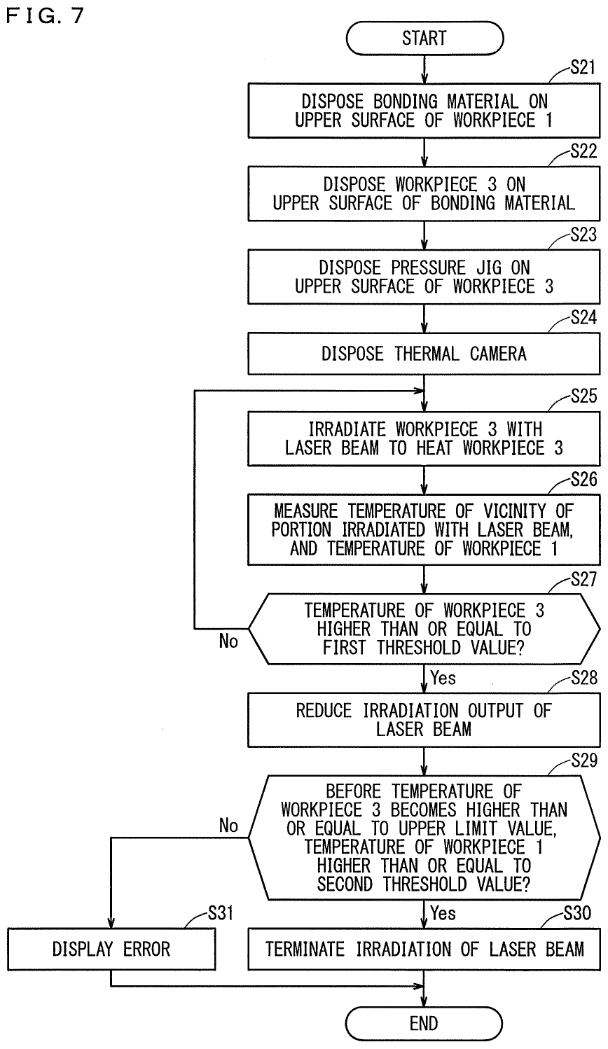

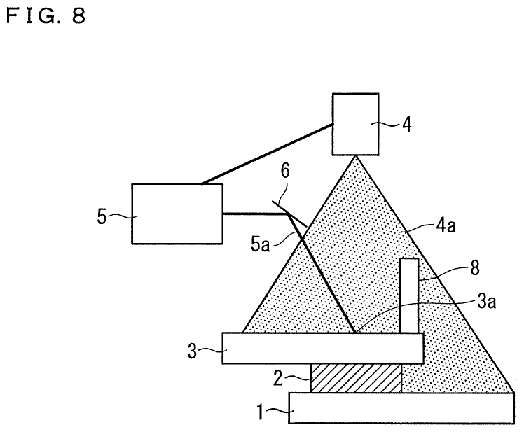

FIG. 7 is a flowchart for illustrating example processes of the bonding method according to Embodiment 5. FIG. 8 illustrates the example processes of the bonding method according to Embodiment 5. The bonding method will be hereinafter described with reference to FIGS. 7 and 8.

First, the bonding material 2 is disposed on the upper surface of the workpiece 1 (Step S21 in FIG. 7). Furthermore, the workpiece 3 is disposed on the upper surface of the bonding material 2 (Step S22 in FIG. 7).

Next, a pressure jig 8 is disposed on an upper surface of the workpiece 3 to press the workpiece 3 against the bonding material 2 and the workpiece 1 (Step S23 in FIG. 7). The pressure jig 8 is made of a material with high heat resistance (e.g., SUS). Furthermore, the pressure jig 8 is disposed on a portion at which measurement of the temperature by the thermal camera 4 is not obstructed (e.g., an end of the upper surface of the workpiece 3 as illustrated in FIG. 8), except a portion irradiated with the laser beam 5a.

Next, the thermal camera 4 is disposed such that the temperatures of both of the workpieces 3 and 1 can be detected (Step S24 in FIG. 7). The thermal camera 4 may be disposed before the pressure jig 8 is disposed (Step S23 in FIG. 7). Then, the laser light source 5 irradiates the workpiece 3 with the laser beam 5a to heat the workpiece 3 (Step S25 in FIG. 7). Here, the thermal camera 4 measures the temperature of the vicinity of the irradiated portion 3a irradiated with the laser beam 5a in the workpiece 3, and the temperature of the workpiece 1 (Step S26 in FIG. 7).

Next, whether the temperature of the workpiece 3 is higher than or equal to the first threshold value is determined (Step S27 in FIG. 7). When the temperature of the workpiece 3 which has been measured by the thermal camera 4 is lower than the first threshold value, the processes return to Step ST25 in FIG. 7 to continue heating the workpiece 3. When the temperature of the workpiece 3 is higher than or equal to the first threshold value, the irradiation output of the laser beam 5a is reduced in Step S28 of FIG. 7. Then, the processes proceed to Step ST29 in FIG. 7.

It is determined, in Step ST29 in FIG. 7, whether the temperature of the workpiece 1 is higher than or equal to the second threshold value before the temperature of the workpiece 3 becomes higher than or equal to the upper limit value. When the temperature of the workpiece 1 is higher than or equal to the second threshold value before the temperature of the workpiece 3 becomes higher than or equal to the upper limit value, irradiation of the laser beam 5a is terminated in Step S30 of FIG. 7, and the bonding through the bonding material 2 is completed. When the temperature of the workpiece 1 does not become higher than or equal to the second threshold value before the temperature of the workpiece 3 becomes higher than or equal to the upper limit value, the device displays an error in Step S31 of FIG. 7, and terminates the operations.

Although SUS is exemplified as a material of the pressure jig 8 with high heat resistance, for example, Cu or Al may be used as the material. Furthermore, the pressure jig 8 may be configured to measure a surface temperature of the workpiece 3 as a contact thermometer, instead of the thermal camera 4.

Pressing the workpiece 3 against the bonding material 2 or the workpiece 1 by the pressure jig 8 can prevent the workpiece 3 from lifting off from the bonding material 2. Consequently, the thermal contact resistance can be reduced. Thus, a bond with high reliability can be stably obtained without damaging peripheral components. In addition, this can prevent a bonding defect created when the bonding material 2 is melted and the workpieces 3 and 1 are separated from each other.

### Advantages Produced by Embodiments Above

Next, example advantages produced by a plurality of Embodiments above will be described. Although the advantages will be described based on the specific structures whose examples are shown in the plurality of Embodiments above, the structures may be replaced with another specific structure whose example is shown in this DESCRIPTION as long as it produces the same advantages. Specifically, although only one of the specific structures is sometimes described as a representative for convenience, the structure may be replaced with another specific structure associated with the structure described as a representative.

Such replacement may be performed across the plurality of Embodiments. Specifically, such replacement may be performed when combined structures whose examples are described in different Embodiments produce the same advantages.

According to Embodiments above, the bonding material 2 is disposed on an upper surface of a first component in the bonding method. Here, the first component corresponds to, for example, at least one of the workpieces 1, 11, or 21. Then, a second component is disposed on the upper surface of the bonding material 2. Here, the second component corresponds to, for example, at least one of the workpieces 3, 13, 23, 33, or 43. Then, a temperature measurement unit is disposed such that the temperatures of the workpieces 1 and 3 can be measured. Here, the temperature measurement unit corresponds to, for example, the thermal camera 4 or a contact thermometer. Then, the thermal camera 4 measures the temperatures of the workpieces 1 and 3 while the workpiece 3 is irradiated with the laser beam 5a. When the measured temperature of the workpiece 3 is higher than or equal to the first threshold value, the output of the laser beam 5a is reduced. After the temperature of the workpiece 3 is higher than or equal to the first threshold value, when the measured temperature of the workpiece 1 is higher than or equal to the second threshold value, the output of the laser beam 5a is terminated.

Such a structure enables obtainment of a stable bond by measuring temperature states of the workpieces 1 and 3 using the thermal camera 4 and appropriately controlling the output of the laser beam 5a according to the temperature states in a heating process by irradiation of the laser beam 5a, without damaging peripheral components with low heat resistance while avoiding excessive energy input.

When the other structures whose examples are described in the DESCRIPTION are appropriately added to the structure above, that is, the other structures in the DESCRIPTION which are not mentioned as the structure above are appropriately added, the same advantages can be produced.

According to Embodiments above, when the temperature of the workpiece 1 is higher than or equal to the second threshold value before the temperature of the workpiece 3 becomes higher than or equal to the upper limit value, the output of the laser beam 5a is terminated. Here, the upper limit value is a temperature higher than the first threshold value. Such a structure can determine whether the heat is appropriately transferred to the workpiece 1 through the bonding material 2. This enables obtainment of a stable bond while avoiding a shortage of the heat transfer to the workpiece 1 which is caused by a large thermal contact resistance.

According to Embodiments above, the first threshold value and the second threshold value are liquidus temperatures of a bonding material. Such a structure enables obtainment of a stable bond by measuring the temperature states of the workpieces 1 and 3 using the thermal camera 4 and appropriately controlling the output of the laser beam 5a according to the temperature states, without damaging peripheral components with low heat resistance while avoiding excessive energy input.

According to Embodiments above, a part of an upper surface of the workpiece 11 (or the workpiece 21) is subjected to a first blackening treatment in the bonding method. Here, the first blackening treatment corresponds to, for example, at least one of the blackening treatment 11a or the blackening treatment 21a. Then, at least a part of an upper surface of the workpiece 13 (or the workpiece 23) is subjected to a second blackening treatment. Here, the second blackening treatment corresponds to, for example, at least one of the blackening treatment 13a or the blackening treatment 23a. Disposing the bonding material 2 on the upper surface of the workpiece 11 includes disposing the bonding material 2 on a region of the upper surface of the workpiece 11 that is not yet subjected to the blackening treatment 11a. Furthermore, measuring the temperatures of the workpieces 11 and 13 by the thermal camera 4 includes measuring the temperatures of the upper surfaces of the workpiece 11 and the workpiece 13 that have been subjected to the blackening treatment 11a and the blackening treatment 13a, respectively, by the thermal camera 4. In such structures, the blackening treatment will improve the temperature measurement accuracy by the thermal camera 4. Since the temperature can be controlled with high accuracy, a stable bond can be obtained.

According to Embodiments above, only the parts of the upper surface of the workpiece 23 are subjected to the blackening treatment 23a. Even when a workpiece is not widely subjected to a blackening treatment under constraints of designing components, partially subjecting the vicinity of a bond to a blackening treatment in the aforementioned structure enables indirect measurement of the temperature of the bond. Since this increase the accuracy of controlling the temperature, a stable bond can be obtained.

According to Embodiments above, the recess 33a is formed in an upper surface of the workpiece 33. Then, the recess 33a is irradiated with the laser beam 5a. Since the recess 33a is formed in the portion to be irradiated with the laser beam 5a in such a structure, the portion has a lower thermal capacity and faster thermal response. Thus, a stable bond can be obtained. Since the heat transfer efficiency of the laser beam 5a to the bonding material 2 and the workpiece 1 increases, a stable bond can be obtained.

According to Embodiments above, the opening 43a is formed in the workpiece 43. Then, the bonding material 2 is directly irradiated with the laser beam 5a through the opening 43a. Since such a structure can directly heat the bonding material 2 with the laser beam 5a, a shortage of heat transfer to the workpiece 1 can be avoided even when the contact thermal resistance is large. Thus, a stable bond can be obtained.

According to Embodiments above, before the workpiece 3 is irradiated with the laser beam 5a, the workpiece 3 is pressed against the bonding material 2 and the workpiece 1. Such a structure can prevent the workpiece 3 from lifting off, and reduce the thermal contact resistance. Since the heat transfer efficiency from the workpiece 3 to the workpiece 1 through the bonding material 2 is increased, a bond with high reliability can be obtained without damaging peripheral components. In addition, it is possible to prevent a bonding defect created when the bonding material 2 is melted and the workpieces 3 and 1 are separated from each other.

### Modifications of Embodiments Above

Although Embodiments described above sometimes specify, for example, properties of materials, the materials, dimensions, shapes, relative arrangement relationships, and conditions for implementing each of the constituent elements, these are examples in all aspects and are not restrictive.

Therefore, numerous modifications and equivalents that have not yet been exemplified are devised within the scope of the technology disclosed in the DESCRIPTION. Examples of the numerous modifications and equivalents include a case where at least one constituent element is modified, added, or omitted, and further a case where at least one constituent element in at least one of Embodiments is extracted and combined with a constituent element in another Embodiment.

When at least one of Embodiments above specifies, for example, the name of a material without any particular designation, the material includes another additive, for example, an alloy unless it is contradictory.

The DESCRIPTION is referred to for all the objectives related to the present technology, and is not admitted as prior art.

### EXPLANATION OF REFERENCE SIGNS

2 bonding material, 4a region, 5a laser beam, 11a blackening treatment, 13a blackening treatment, 21a blackening treatment, 23a blackening treatment, 33a recess, 43a opening

1. A bonding method, comprising:
disposing a bonding material on an upper surface of a first component;
disposing a second component on an upper surface of the bonding material;
disposing a temperature measurement unit such that temperatures of the first component and the second component can be measured;
measuring the temperatures of the first component and the second component using the temperature measurement unit, with the second component being irradiated with a laser beam;
reducing output of the laser beam when the measured temperature of the second component is higher than or equal to a first threshold value; and
terminating the output of the laser beam when the measured temperature of the first component is higher than or equal to a second threshold value after the temperature of the second component is higher than or equal to the first threshold value.

2. The bonding method according to claim 1,
wherein the terminating includes terminating the output of the laser beam when the temperature of the first component is higher than or equal to the second threshold value before the temperature of the second component becomes higher than or equal to an upper limit value, and
the upper limit value is a temperature higher than the first threshold value.

3. The bonding method according to claim 1,
wherein the first threshold value and the second threshold value are liquidus temperatures of the bonding material.

4. The bonding method according to claim 1, the method comprising:
subjecting a part of the upper surface of the first component to a first blackening treatment; and
subjecting at least a part of an upper surface of the second component to a second blackening treatment,
wherein the disposing of the bonding material includes disposing the bonding material on a region of the upper surface of the first component, the region being not subjected to the first blackening treatment, and
the measuring includes measuring temperatures of the upper surfaces of the first component and the second component that have been subjected to the first blackening treatment and the second blackening treatment, respectively, using the temperature measurement unit.

5. The bonding method according to claim 4,
wherein only the part of the upper surface of the second component is subjected to the second blackening treatment.

6. The bonding method according to claim 1, the method comprising:
forming a recess in an upper surface of the second component; and
irradiating the recess with the laser beam.

7. The bonding method according to claim 1, the method comprising:
forming an opening in the second component; and
directly irradiating the bonding material with the laser beam through the opening.

8. The bonding method according to claim 1, the method comprising
pressing the second component against the bonding material and the first component before the second component is irradiated with the laser beam.
